(19) United States
(12) Patent Application Publication
(10) Pub. No.: US 2005/0071169 A1
(43) Pub. Date: Mar. 31, 2005

(54) Method and control system for the voice control of an appliance

(76) Inventor: Volker Steinbiss, Aachen (DE)

Correspondence Address: U S Philips Corporation;Intellectual Property Department, PO Box 3001, Briarcliff Manor, NY, 10510, US

(21) Appl. No.: 10/498,949

(22) PCT Filed: Dec. 16, 2002
(86) PCT No.: PCT/IB02/05466

(30) Foreign Application Priority Data
Dec. 21, 2001 (DE) 101632142

(51) Int. Cl. G10L 11/00

(52) U.S. Cl. 704/275; 704/200

(57) ABSTRACT

A method is disclosed for the voice control of an appliance in which a voice signal (S) of a user is supplied to a voice recognition device for recognizing a command or a command sequence. Depending on the command recognized by the voice recognition device or the command sequence, an appropriate action (A) or action sequence (AS, AR) of the appliance is performed. A reference time instant (tr) is determined as a function of the occurrence and/or time variation of the voice signal (S). The action (A) or action sequence (AS, AR) of the appliance then takes place in a certain time instant referred to the reference time instant (tr) and/or an action parameter value is determined as a function of the reference time instant (tr), which action parameter value is used in the action (A) or action sequence (AS, AR). In addition, a suitable control system is disclosed.

The invention relates to a method for the voice control of an appliance in which a voice signal of a user is fed to a voice recognition device for recognizing a command or a command sequence and, depending on the command recognized by the voice recognition device or a command sequence, an appropriate action or action sequence of the appliance is carried out. In addition, the invention relates to a voice control system for performing such a method.

Voice recognition methods are increasingly used in a very wide variety of sectors to control a very wide variety of appliances by the user using voice commands. Typical application sites that are already standard at present are controllers of peripheral appliances in motor vehicles, such as radios, mobile radios or navigational systems. Here, the advantage that a voice controller makes hands-free operation of the respective appliance possible and, consequently, the driver of the motor vehicle can control the appliance and can at the same time continue to use his hands to control the motor vehicle without adverse effect, makes itself particularly noticeable. Furthermore, such controllers are of particular benefit for those individuals that are considerably limited, for example, in their movement and therefore have only their voice available as a means of control. A voice controller has, in addition, the general advantage that, as distinct from methods in which a keyboard or the like is used, the user interface is adapted to the main human communication means, namely the voice. In addition, because the voice commands for the voice controller are transmitted wirelessly to the respective appliance, the advantage is obtained of a quite natural (that is to say, as a rule, achievable without extra cost) short-range remote control of the appliance. Ever more appliances used in daily life, for example kitchen appliances or entertainment electronics devices, are therefore also generally equipped with voice controllers. In this connection, a voice control is possible not only in the case of individual appliances, such as, for example, a video recorder or a television, but in principle in the case of any electronically controllable device. In particular, any complex appliance systems, for example, a networked domestic or office electronics system, can also be controlled thereby. In the same way, it is, for example, possible to “surf” the Internet via a computer by means of voice control. It is therefore expressly pointed out that the term “appliance” used here is to be understood comprehensively in this respect.

In the case of a voice controller, a command or a command sequence pronounced by the user is normally detected, for example, by means of a microphone, as a voice signal. Said voice signal is then passed to a voice recognition device that passes said command or the command sequence in turn to a control device of the respective appliance as soon as it has recognized said command or the command sequence from the voice signal that has been input. The control device then controls the respective components of the appliance in the desired way so that the command given by the user is performed as quickly as possible. Although all the components of the voice control signal operate very rapidly, a certain time delay is however always unavoidable between the pronouncement of the command by the user and the execution by the appliance. The greatest portion of the time delay arises in this connection in most cases in the voice recognition because, for example, a certain time interval is needed in order to be able to establish reliably whether a command is actually completed or is still being continued. Thus, for example, after recognizing the command “channel twenty” it is necessary to ensure that the input “two” does not also follow, which would then result in total in the command “twenty two” desired by the user. In this connection, the time interval between the pronouncement and the execution of the command is not, in an unfavorable way, precisely defined since the voice recognition device itself does not always need the same time for identical commands in order to recognize the command. Thus, in addition to the command itself, many further parameters, for example background noise components during the input of voice signals (or in the case of more complex systems, those that can execute a plurality of computer operations simultaneously) influence the actual loading of the system and the time required to recognize a command. Such a time response of the voice control system is disadvantageous, on the one hand, since different delay times may contribute to making the user unsure. For example, if the recognition time is fairly long, the user is often uncertain whether the command has been received at all. This can have the result that the user unnecessarily inputs the command repeatedly. A further disadvantage also arises, in particular, if a command is involved for an appliance for which the time response is critical. A typical example of this is the precise stopping of a running audio or video appliance at a particular position, for example at a particular picture.

One way of circumventing this problem is to accelerate the recognition of the command. An example of a relatively simple and therefore fast recognition of a command is disclosed, inter alia, in DE 41 03 913 A1. In this case, it is proposed to generate a measurement signal characterized by a time pattern from the spoken sentence or the spoken command instead of a complete voice recognition, the time pattern relating to the sound duration or pause duration of the signal. Said time pattern of the measurement signal is then compared with the time pattern of a pattern signal and, in the event of coincidence of the time pattern, the control signal corresponding to the pattern signal is then generated. However, this method is limited to simple voice controllers having a very limited repertoire of voice commands, which must accordingly differ considerably in relation to their time pattern. In other respects, even with an appreciable reduction in the recognition time, it can still not always be ensured that, when a command is input, the recognition time varies and results in the problems mentioned.

It is an object of the invention to provide an alternative to this prior art that avoids the problems mentioned.

This object is achieved in that, depending on the occurrence and/or time variation of the voice signal, a reference time instant is determined and in that the action or action sequence of the appliance takes place in a certain time scheme relative to the reference time instant and/or that, depending on the reference time instant, an action parameter value is determined that is used during the action or action sequence.

In addition, the object is achieved by a suitable voice control system that has an analysis device for a detected voice signal for determining such a reference time instant and whose control device activates the appliance in such a way that the action or action sequence of the appliance takes place in a certain time scheme relative to the reference time instant and/or that the control device determines an action parameter value as a function of the reference time instant and uses said action parameter value in activating the appliance.

The voice control system may at the same time be a component of the appliance itself. However, a separate voice control system may be involved that is connected upstream of said appliance or even a plurality of appliances within a more complex system and only issues the control commands to the individual appliances to be controlled or further system components.

The dependent claims contain particularly advantageous embodiments and developments of the invention.

The analysis necessary to determine the reference time instant may be performed either independently or dependently of the actual voice recognition, for example prior to the voice recognition. In this connection, the voice control system needs, in the simplest case, only a relatively primitive additional analysis device that detects, for example, only the beginning and/or the end of a voice signal. If a more precise analysis is desired for the determination of a reference time instant, on the other hand, the analysis device must equally be of more complex design, in which case it may be appropriate to use as an analysis device the voice recognition device or parts of the voice recognition device concomitantly in order to fix a suitable reference time instant. In such a case, it is particularly advantageous if the voice recognition device used as an analysis device delivers the analytical result for determining the reference time instant as early as possible and not just when the recognized command or the command sequence is delivered.

According to the invention, the action or action sequence of the appliance is then performed in a certain time scheme (for example from a certain time instant) relative to said reference time instant. Alternatively or additionally, an action parameter value is determined as a function of the reference time instant and is then used during the action or action sequence. Such an action parameter may be, for example, a certain rewind time in an appliance, such as, for example, a video recorder with forward wind/rewind function. Such an action parameter may, however, also be a time that is calculated from a user time specification, for example a command such as “5 more minutes”, account being taken of the calculation of the reference time interval by the user's time specification being referred to the reference time instant.

Establishing an absolutely fixed reference time instant in time (referred to the detected voice signal) and the execution of the subsequent action or action sequence within a certain time scheme (referred to said reference time instant) ensures that the time that is recognizable for the user and that the appliance or the voice control system needs to execute the command is essentially always the same and does not depend on how quickly the voice recognizer was capable in each case of extracting the command or the command sequence from the voice signal. The user thus automatically acquires a feeling for the time response of the appliance and is not confused by different recognition times. Determining an action parameter value as a function of the respective reference time instant even makes it possible to compensate for the time delay between pronouncement and execution of the command in the case of those commands for which the time response is crucial.

The widest variety of time instants within the time period of the voice signal are suitable as reference time instants. Reference time instants that can be fixed particularly easily are, for example, the beginning or the end of the voice signal. These can be detected very quickly with a simple voice activity detector.

In the same way, it is possible to select the time instant of the occurrence of a certain characteristic feature in the voice signal as a reference time instant. Such a characteristic feature can be determined, preferably, with the aid of the beginning and/or the end of a certain phoneme or of a section of the voice signal. In this connection, in the simpler case, the beginning or the end of the phoneme or of the section of the multi-part voice signal may itself serve as a reference time instant. However, it is also possible to use more complicated algorithms and, for example, to choose a mean time value between the beginning and the end of a certain phoneme or section as a reference time instant.

In that case, the reference time instant is preferably chosen in such a way that it can be detected as easily and reliably as possible in a certain command so that the same reference time instant is always chosen if said command is input. A typical, very easily recordable characteristic feature is, for example, the beginning of the vowel “e” in a command “TV now”.

In a preferred embodiment, the appliance is controlled in such a way that the action time instant of the appliance at which the action or action sequence of the appliance begins has a defined time interval (i.e. a defined delay time) with respect to the reference time instant.

In a further preferred embodiment, the time scheme is always dependent on the command input. Thus, for example, the delay time can always be adjusted to precisely one second in the case of a switch-on command for an appliance, whereas, in the case of a stop command, in particular, for example, an emergency stop, the time scheme is chosen in such a way that the appliance stops immediately after recognizing the stop command.

The time scheme may also be chosen in such a way that the command must be executed within a certain time interval between a minimum time and a maximum time. The action or action sequence then takes place at the earliest after the elapse of the minimum time of, for example, one second. If recognition of the signal was not possible until then, the command is executed immediately after receiving the recognized signal. After exceeding the maximum time, for example after 1.5 seconds, the voice control signal discontinues the process and gives the user an appropriate signal, for example a “command not recognized” message.

The time scheme is preferably chosen in such a way that, under normal conditions, recognition of the possible commands or command sequences is possible within the fixed delay time or the minimum time so that the action or action sequence of the appliance starts with pinpoint accuracy after the predetermined time has elapsed.

If the system recognizes that the predetermined time instant has already elapsed before the command or command sequence has been recognized, various possibilities exist for avoiding such situations in the future. One possibility is to alter the time scheme and, for example, increase the preset delay time or minimum time. Another possibility is to vary, so far as is possible, the parameters of the voice recognition unit and/or the system resources in order to be able to perform the recognition more quickly the next time.

In addition, if it establishes that the predetermined time instant is threatening to expire, the system can enforce a decision under various already established hypotheses of the voice recognition unit to obtain a recognition result immediately. If the predetermined time instant is dependent on the recognition result and, consequently, dependent on the respective hypothesis, the system can respond accordingly as soon as the time instant for one of the hypotheses has elapsed.

In a preferred embodiment, the time interval up to an action time instant of the appliance in accordance with claim 6 is bridged by the delivery of a signal reception confirmation to a user. Such a signal reception confirmation may, for example, be an audible or visual signal, such as the lighting up of a light-emitting diode or the like. At the same time, said signal reception confirmation is delivered in a precisely defined time scheme.

The delivery of such a signal reception confirmation is appropriate, in particular, if the delay time is made relatively long in order to have sufficient computing time available for the recognition of the command. Such a reception confirmation that is predictable for the user after pronouncing the voice command and prior to its execution achieves a better user feeling since the user thereby finds that his voice command brings about something immediately, i.e. that the appliance or the voice controller is active with respect to his voice command.

For this purpose the voice control system needs a signaling device in order to deliver the signal reception confirmation to the user, and the control device must accordingly be designed to activate the signaling device in accordance with the requirements.

In a particularly preferred embodiment, a desired action time instant is first defined in relation to the reference time instant. Such a desired action time instant is the time instant at which the action desired by the user would be performed. A typical example of this is the stopping of a video recorder or DVD recorder at a very precisely defined time instant, that is to say at a very specific picture. As soon as the user recognizes said picture, he expresses the voice command “stop” and expects that the recorder will stop precisely at said picture.

In this connection, the reference time instant itself can in principle be defined as desired action time instant, in particular if the beginning of the detected voice signal is chosen as the reference time instant. Preferably, however, the reaction time of the user himself is taken into account in the definition of the desired action time instant in relation to the reference time instant. For this purpose, for example, a time instant prior to the reference time instant is chosen as the desired action time instant, the interval between the desired action time instant and the reference time instant being equal to a mean user reaction time, for example 0.2 seconds.

A “reaction time” between the defined desired action time instant and the real actual action time instant of the appliance is determined. Since the user reaction time is taken into account, this is the total reaction time of the entire system comprising the user, the voice control system and the appliance. An action parameter value for the action or action sequence of the appliance to be performed is then determined from said reaction time and the reaction time is again compensated for in performing the action or action sequence using said action parameter value.

This method is suitable, in particular, for all appliances that have a media input and/or output unit with a forward-run and/or backward-run function. In addition to the video recorders or DVD recorders mentioned, such appliances also include appliances such as tape recorders, CD players or any other desired appliances that can output a data sequence visually and/or audibly in a time sequence to the user and/or for which the user can correspondingly input data, such as, for example, a film camera. These appliances consequently also include computers or similar appliances having appropriate software that output, for example via the Internet or from a memory, for example of the hard disk or a diskette drive or DVD drive, a sequence of lecture transparencies, search lists, etc. to the user and for which the user has the possibility of stopping said output with pinpoint precision.

As a rule, it is possible in such media input and/or output units to approach a desired point, i.e. a certain data set or, for example, a picture with the forward-run and/or backward-run function. In this connection, there is usually the possibility to run forward or run backwards at various speeds, a forward run or backward run taking place in different modes without outputting data and the data being displayed to the user in other modes (search or simple playback). In the case of such appliances, a backward-run value or a forward-run value can be determined as an action parameter value from the reaction time determined depending on whether the stop command takes place in order to stop the appliance during a forward run or a backward run. At the given action time instant, the media input and/or output unit is then first stopped in an action sequence and driven back again or driven forward in accordance with the backward-run value or forward-run value determined so that the reaction time is compensated for.

The method can in principle be performed purely by software using a computer program, for example by means of appropriate software modules on a suitable computer. In that case, the voice recognition device can be formed by a software voice recognition module and the control device by a software control module. In the same way, a voice output device may be implemented with a TTS (text-to-speech) module. A dialog control module can be installed on the computer to control the dialog with a user. All these modules then have to be combined with one another in a suitable way, for example as subroutines and main routines in order to interact in accordance with the method according to the invention. The computer must, of course, be connected to a suitable device for detecting a user's voice signal, for example a microphone.

In this connection, the various software modules may also be installed in various, mutually networked computers instead of in an individual computer. Thus, for example, a first computer may comprise the control module and a dialog control module, whereas the relatively computationally intensive automatic voice recognition is performed, if necessary, in a second computer.

These and other aspects of the invention are apparent from and will be elucidated with reference to the embodiments disclosed hereinafter. In the Figures:

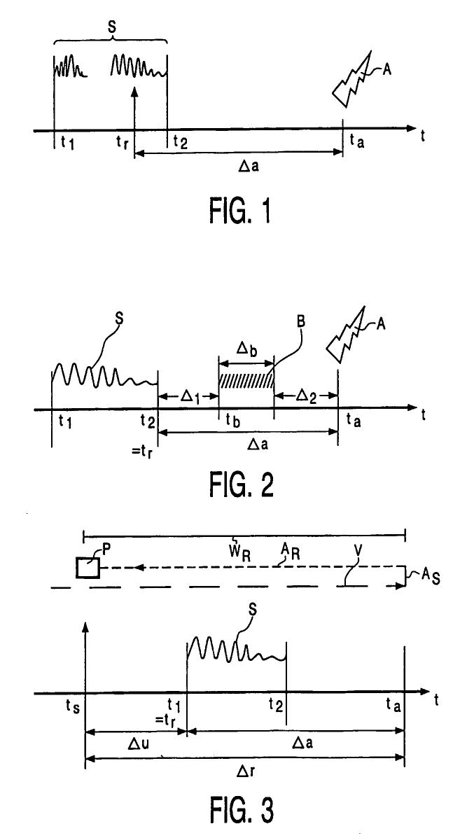

FIG. 1 shows a diagrammatic representation of the time period from the pronouncement to the execution of a voice command to set a fixed delay time between the reference time instant and an action time instant,

FIG. 2 shows a diagrammatic representation of a time period as in FIG. 1, in which, however, the delay time between the reference time instant and the action time instant is bridged by an actuation signal,

FIG. 3 shows a diagrammatic representation of the time period in the case of a precise picture stop of a video recorder.

In the Figures, the time period of the occurrence of the voice signal S and also of the action A or the action sequence A_{S}, A_{R} of the appliance are plotted against time t. In the embodiments shown, the voice signals always start at time instant t₁ and finishes at time instant t₂.

The embodiments shown in the first two Figures are in each case a television set voice controller.

FIG. 1 shows a first variant of the method, in which the voice command S is a switch-on command for the TV set, in this case the word sequence “TV on”. The voice signal S consequently comprises two signal sections corresponding to the two words “TV” and “on”. A particular, easily detectable feature in the second section of the voice signal S, that is to say in the word “on”, was chosen as reference time instant tᵣ. In the specific case, the end of the vowel “o” in the word “on” is the reference point in this connection.

As soon as the voice signal S is detected, it is passed to a voice recognition device, which analyses the voice signal further in order to recognize the command communicated therein or the command sequence. The command sequence “TV on” is then passed to a control device, which switches on the television set. This switch-on action A does not, however, take place immediately after the recognition of the command sequence by the voice recognition device, but only at a defined action time instant tₐ that is at a fixed time interval Δₐ with respect to the reference time instant tₐ. The action A consequently always takes place independently of the time duration of recognition after a fixed delay time Δₐ after the user has spoken the “o” in the word “on”. In this connection, it is assumed that the delay time Δₐ between the reference time instant tᵣ and the action time instant tₐ is long enough for the voice recognition device to be able to recognize the command sequence in the voice signal S.

FIG. 2 shows a variant of the method. In this case, the switch-on command is a command comprising one word, namely the word “on”. Accordingly, a single-part voice signal S is involved that starts again at a time instant t₁ and finishes at a time instant t₂. In this case, the end of the voice signal S is simply chosen as reference time instant tᵣ. This one-word command “on” is chosen in FIG. 2 only to present a further example of a voice signal and a reference time instant. It is clear that the invention is independent of the specific command and that, in the exemplary embodiment in accordance with FIG. 2, the command “TV on” could be used in the same way or the command “on” or the like could be used in the exemplary embodiment according to FIG. 1.

In the case according to FIG. 1, the voice signal S is supplied to a voice recognition system and then the action A, i.e. the television set is switched on, is performed at the action time instant tₐ after a precisely defined delay time Δₐ. As a departure from the embodiment according to FIG. 1, however, the delay time Δₐ between the reference time instant tᵣ and the action time instant tₐ is bridged by an actuation signal B, which is delivered to the user. Said actuation signal B is also delivered according to a precisely predetermined time scheme as a function of the reference time instant tᵣ. In the present exemplary embodiment. a light-emitting diode is switched on at a time instant t_{b} after a precisely predetermined first time interval Δ₁, which light-emitting diode lights up for a precisely defined second time interval Δ_{b} and is switched off again after a precisely defined third time interval Δ₂ prior to the defined action time instant tₐ. The first and the third time intervals Δ₁, Δ₂ could in this case each be, for example, 0.2 seconds.

It goes without saying that it is also possible to vary said time intervals Δ₁, Δ₂ and, for example, to display the actuation signal B until the action time instant tₐ is reached, that is to say the second time interval Δ₂ is set to zero. Switching-off the actuation signal B prior to the start of the desired action A, that is to say before the action time instant tₐ is, however, expedient, in particular, if the actuation signal is not a visual signal but an audible signal, such as a peeping sound, and if the total time interval between the reference time instant tᵣ and the action time instant tₐ, i.e. the delay time Δₐ, is longer. In this case, an audible actuation signal B lasting longer would probably irritate the user. A short audible signal, for example approximately in the middle of the total time interval Δₐ between the reference time instant tᵣ and the action time instant tₐ, is, on the other hand, found to be less disturbing. It goes without saying that it is also possible to emit a plurality of actuation signals at precisely predetermined time periods, for example to repeat an actuation signal several times, until the action time instant tₐ has finally been reached. In the same way, a combination of audible and visual or other actuation signals is also possible.

Finally, FIG. 3 shows a further variant of the invention, in which the reaction time Δᵣ between a desired action time instant tₛ and a real action time instant tₐ is again compensated for by a defined action sequence A_{S}, A_{R} of the appliance. The present case involves stopping a video recorder with picture accuracy.

At the desired action time instant tₛ, the user sees the picture P and would like to stop the video recorder at this position. After a certain user reaction time Δᵤ of, for example, 0.2 seconds, he pronounces the command “stop” at the time instant t₁. The voice signal S then starts at the time instant t₁, which is later than the desired action time instant tₛ and finishes at the time instant t₂. In this example, the beginning of the voice signal, that is to say the time instant t₁, is taken as the reference time instant tᵣ so that t₁ and tᵣ are identical. However, any other desired reference time instant tᵣ may be chosen.

In the embodiments according to FIGS. 1 and 2, the voice signal S is then analyzed in a voice recognition device and the command “stop” is recognized in this process. After a precisely defined delay time Δₐ following the reference time instant tᵣ, the appliance is finally actually stopped at an action time instant tₐ.

From FIG. 3, it becomes clear that there is an appreciable time difference, which is due, on the one hand, to the user reaction time Δᵤ and, on the other hand, to the set delay time Δₐ between the reference time instant tᵣ and the action time instant tₐ, between the real actual action time instant tₐ and the desired action time instant tₛ at which the appliance should stop per se. During this “total reaction time” Δᵣ of the entire system, comprising user, voice recognition system and appliance, the appliance is in the forward-run mode V for the whole time. That is to say, the appliance stops at the action instant tₐ at a completely different picture from that desired by the user.

Since the reaction time instant Δᵣ, however, can be calculated with the aid of the reference time instant tᵣ (in which case, however, the user reaction time Δᵤ can be taken only as a mean for various average users), it is possible to determine from the reaction time Δᵣ a backward-run value W_{R} for which the videotape must run backwards in order to reach the position comprising the picture P desired by the user.

Said backward-run value W_{R} may be a time for which the videotape in the recorder must run backwards at a certain speed. It may, however, also be a tape length specification or a similar parameter. In the case of a DVD recorder or a CD player, the precise position on the data medium may, incidentally, also be determined as a parameter, which precise position is then approached as the destination.

In the embodiment according to FIG. 3, the recorder is consequently not simply stopped at the action time instant tₐ, but an action sequence A_{S}, A_{R} is initiated and comprises a stop action A_{S} and an immediate backward-run action A_{R} of the appliance so that the appliance is actually at the position desired by the user, i.e. at picture P, at the end of the action sequence A_{S}, A_{R}.

The invention therefore improves, on the one hand, the user's experience in controlling the appliance since the user instinctively develops a feeling for it even after a short time as a result of the predictability of the time periods for when the appliance is functioning correctly and when problems have arisen in the voice control system, in particular recognition problems or the like. In special cases, such as, for example, in the case of a pinpoint stopping of a media input and/or output, it is even possible to compensate for the delay time of the appliance and, if desired, also the reaction time of the user himself with the aid of the invention.

1. A method for the voice control of an appliance in which a voice signal (S) of a user is fed to a voice recognition device for recognizing a command or a command sequence and, depending on the command recognized by the voice recognition device or a command sequence, an appropriate action (A) or action sequence (A_{S}, A_{R}) of the appliance is initiated, characterized in that, depending on the occurrence and/or time variation of the voice signal (S) a reference time instant (tᵣ) is determined and in that the action (A) of action sequence (A_{S}, A_{R}) of the appliance takes place in a certain time scheme relative to the reference time instant (tᵣ) and/or, depending on the reference time instant (tᵣ), an action parameter value (W_{R}) is determined that is used during the action (A) or action sequence (A_{S}, A_{R}).

2. A method as claimed in claim 1, characterized in that the beginning (t₁) or the end (T₂) of the voice signal (S) is fixed as a reference time instant (tᵣ).

3. A method as claimed in claim 1, characterized in that the time instant of the occurrence of a certain characteristic feature (M) in the voice signal (S) is fixed as a reference time instant (tᵣ).

4. A method as claimed in claim 3, characterized in that the characteristic feature is determined with the aid of the beginning and/or the end of a certain phoneme of the voice signal and/or the beginning and/or the end of a certain section of a multi-part voice signal.

5. A method as claimed in claim 1, characterized in that an action time instant (tₐ) of the appliance at which the action (A) or action sequence (A_{S}, A_{R}) Of the appliance begins has a defined time interval (Δₐ) with respect to the reference time instant (tᵣ).

6. A method as claimed in claim 1, characterized in that a time interval up to an action time instant (tₐ) of the appliance at which the action (A) or action sequence (A_{S}, A_{R}) of the appliance begins is bridged by delivery of a signal reception confirmation (B) to a user, wherein the signal reception confirmation (B) starts at a defined time instant (t_{B}) after the reference time instant (tᵣ).

7. A method as claimed in claim 1, characterized in that a reaction time (Δᵣ) is determined between a desired action time instant (tₛ) defined in relation to the reference time instant (tᵣ) and the real actual action time instant (tₐ) of the appliance at which the action (A) or action sequence (A_{S}, A_{R}) starts, and an action parameter value (W_{R}) for the action (A) or action sequence (A_{S}, A_{R}) of the appliance to be performed is determined from the reaction time (Δᵣ) determined and, during the performance of the action (A) or action sequence (A_{S}, A_{R}), the reaction time (Δᵣ) is compensated for using said action parameter value (W_{R}).

8. A method as claimed in claim 7, characterized in that a user reaction time (Δᵤ) of the user who delivers the voice signal (S) is taken into account in the definition of the desired action time instant (tₛ) with respect to the reference time instant (tᵣ).

9. A method as claimed in claim 7, characterized in that the appliance has a media input and/or output unit having a forward-run and/or backward-run function and in that, when a voice signal (S) that comprises a stop command for the media input and/or output unit is input, a backward-run value (W_{R}) or a forward-run value is determined as action parameter value (W_{R}) from the reaction time (Δᵣ) determined and the media input and/or output unit stops at an action time instant (tₐ) in an action sequence (A_{S}, A_{R}) and runs backwards or runs forward again according to the backward-run value (W_{R}) or forward-run value determined.

10. A voice control system for performing a method as claimed in claim 1, comprising means for detecting a voice signal (S), a voice recognition device for analyzing the voice signal (S) to recognize a command or a command sequence and a control device for controlling the appliance as a function of the command recognized by the voice recognition device or of a command sequence so that the appliance performs an action (A) or action sequence (A_{S}, A_{R}) corresponding to the command or the command sequence, characterized in that the voice control system has an analysis device for a voice signal (S) for determining a reference time instant (tᵣ) as a function of the occurrence and/or time variation of the voice signal (S) and is designed in such a way that the control device activates the appliance in such a way that the action (A) or action sequence (A_{S}, A_{R}) of the appliance takes place in a certain time scheme referred to the reference time instant (tᵣ) and/or that the control device determines an action parameter value (W_{R}) as a function of the reference time instant (tᵣ) and uses said action parameter value (W_{R}) in activating the appliance.

11. A computer program having program code means for executing all the steps of a method as claimed in claim 1 if the program is executed on a computer.
